(19) United States
(12) Patent Application Publication
(10) Pub. No.: US 2010/0332416 A1
(43) Pub. Date: Dec. 30, 2010

(54) Medical expenses funding and payment program

(76) Inventor: Nadarasa Visveshwara, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/459,130

(22) Filed: Jun. 25, 2009

(51) Int. Cl. G06Q 90/00

(52) U.S. Cl. 705/500

(57) ABSTRACT

A method for funding and paying for medical expenses that are not otherwise covered by an insurance plan, particularly elective medical procedures. The funding and payment program includes a managing organization that assists a consumer with identifying what medical services are available, which medical providers provide those services, the costs of the desired services and the potential funding sources to pay for those services. The managing organization works through the consumer's employer and directs the consumer to participating financial institutions who can loan funds to pay for the medical services and directs the consumer to participating medical providers who have the desired qualifications. The financial institution issues a pre-approved debit card or other payment mechanism to the consumer so the medical provider can be paid as soon as the services are provided. Under the program, the consumer has control over which services to obtain and which provider provides those services.

### CROSS-REFERENCE TO RELATED APPLICATIONS

None.

### BACKGROUND OF THE INVENTION

A. Field of the Invention

The field of the present invention relates generally to methods of funding services for medical procedures. More particularly, the present invention relates to methods of obtaining funding for medical services and then paying for those medical services. Even more particularly, the present invention relates to methods of funding and paying for non-critical, optional medical services that are not normally covered by health insurance programs.

B. Background

One of the major current issues facing consumers and employers is the cost of healthcare services. The cost of obtaining most medical procedures has increased somewhat significantly in the last decade or so. Although many people are covered by a health insurance program, often paid for at least in part by their employer, many other people do not have any health insurance. Due to the increase in the cost of medical services, the cost of health insurance has also increased significantly, often exponentially. As a result of the increase in health insurance costs, many small and moderate-sized business have had to eliminate or at least significantly reduce the amount of health insurance coverage they provide to their employees and/or the number of employees who are covered by the employer-paid health insurance program. Even many large companies, including a number of multi-national corporations, have had to take similar steps to reduce their health insurance costs. One of the steps that employers, whether large or small, have taken to reduce their health-related costs is to shift at least some of the health care cost burden to their employees by increasing the amount the employee must contribute to his or her health insurance premiums and/or to increase the amount that must be directly covered by the employee before the employer based insurance pays for medical services and related expenses. For businesses or individuals who must pay the ever-increasing premiums for health insurance, one approach to control the costs of such insurance has been to raise the deductible amount, which must be paid by the person, or his or her family, needing medical services prior to the health insurance company beginning to pay for such services. An additional approach to controlling health insurance costs is to limit the types of medical procedures that are covered by the employer's health insurance plan.

The high costs associated with medical services, the lower coverage provided by most insurance companies and/or employers and the weakened economy in general has had a significant negative impact on consumers of such medical services (i.e., patients) and on providers of medical services, particularly physicians and hospitals. For instance, as a result of the high costs associated with obtaining medical services, many people have chosen to put off or even avoid having medical procedures performed and to postpone some of the primary and/or preventive care they would normally obtain. While life-saving or otherwise medically necessary procedures generally cannot be avoided, consumers are choosing to postpone, often indefinitely, all medically elective procedures. As is becoming more common, much of what is considered elective care is no longer covered by insurance companies. To pay for medically elective medical services they desire to have, many people utilize their own savings or charge the services to credit cards (when available). Those medical providers who typically rely on “cash patients,” such as dentists, orthodontists, ophthalmologists, orthopedic surgeons, plastic surgeons, physical therapists, psychiatrists and in vitro fertilization clinics, have all seen a significant reduction in the number of patients that they treat. The reduction in the number of patients for elective procedures is further fueled by the fact that a growing number of consumers are going outside the United States for medical care (both necessary and elective procedures). A recent study estimated that approximately 700,000 people chose to go overseas for medical care in 2007 and that the number of such patients will likely increase to approximately 6,000,000 by 2010.

In the United States, some consumers have taken advantage of the availability of Health Savings Accounts (“HSA”) to help them offset the problems associated with paying for medical services. The law creating HSA allows individuals to place up to $3,000 and families to place up to $5,900 in a tax deductible plan to pay for medical expenses. If not used in a single year, the funds in a HSA can be “rolled over” to the following year. The funds in a HSA may be invested, similar to IRA or 401K plans, and allowed to grow for eventual use to pay medically-related expenses. Unfortunately, today's market rates and other returns on investment results in HSA not having a significant impact on consumer elective care.

In addition to the foregoing, traditional consumer lending programs generally are configured to provide funding for consumers who desire to obtain elective medical care or other medical services that are not covered or not fully covered by an existing health insurance program or available through a HSA or other funding source. Despite the various problems with funding elective and other medical care, many people desire to utilize medical services to have such procedures performed. Medical providers who choose to “finance” all or part of the consumer's elective procedures by accepting future payments, with or without a down payment, run the risk of the consumer defaulting on his or her payments and the creation of problems in the doctor/patient relationship with regard to late or non-existent payments. In addition, such payment programs increase the provider's overhead costs and can result in loss of income, some of which may be significant, due to “write-offs” or written down debt.

What is needed, therefore, is an improved method of funding and paying for medical expenses, particularly medical expenses associated with elective medical care or other medical care that is not otherwise covered by employer programs, health insurance or other conventional funding sources. The improved method of funding and paying for medical expenses should be configured such that it is controlled by the consumer, including the choice of medical procedure to be had, the timing for the procedure, the location for the procedure and the choice of medical provider. The improved method should also be configured to cooperatively engage funding institutions, including banks and the like, to pre-qualify the consumer and arrange for beneficial funding for the consumer and then direct the payment to the medical provider. An improved method of funding and paying for elective medical procedures should also be configured to work with employers and consumers to provide quality assurance guidelines and oversight with regard to provider credentials, procedure outcomes and other performance measures and with regard to retail pricing.

### SUMMARY OF THE INVENTION

The medical expenses funding and payment program of the present invention provides the benefits and solves the problems identified above. That is to say, the present invention discloses an improved method of funding and paying for medical expenses related to procedures, including elective medical services, that are not covered by existing health insurance plans, employer-based health care funding or other sources of funding medical expenses. The new medical expenses funding and payment program of the present invention provides a funding source for medical services that is controlled by the consumer, allowing him or her to choose what procedure is to be performed, when the procedure is to be performed, where the procedure is to be performed and which medical provider(s) will perform the procedure. The improved medical expenses funding and payment program of the present invention cooperatively engages lending institutions, including banks and the like, to pre-qualify the consumer for funds that can be utilized for the medical procedure(s) of his or her choice, arrange for funding for the consumer at a rate he or she can afford and then forward the payments directly to the medical provider performing the medical procedure. The method of funding and paying for medical expenses, particularly including elective medical procedures, provides a program that helps employers and their employee consumers with regard to quality assurance issues, including but not limited to oversight of the medical providers, identification of medical providers with the desired credentials and experience, anticipated outcomes for medical procedures, cost of selected procedures and other medical-related performance measures.

According to one aspect of the present invention, the medical expenses funding and payment starts with the consumer deciding that he or she desires to obtain medical services that are not covered by his or her insurance plan, typically an employer-based insurance plan that does not cover elective procedures and the like. The consumer is directed to a managing organization, typically by the consumer's employer, to assist the consumer with understanding the desired medical services and the risks and effects of such medical services and identifying one or more medical providers who provide such medical services and the costs associated with such services. The managing organization will then assist the consumer with obtaining funds to pay for the desired medical services by directing the consumer to one or more financial institutions with whom the managing organization has a relationship and which has indicated it is willing to provide funds to pay for medical services. The consumer will approach one or more of the financial institutions to obtain the necessary funds. The consumer will then select at least one of the one or more medical providers to provide the medical services and one of the one or more financial institutions to provide funding. The selected financial institution will issue a payment means to the consumer that has a pre-approved amount of funds available to pay for the desired medical services. In the preferred embodiment, the payment means is a debit card or the like. The consumer will then obtain the medical services from the selected medical provider and pay for those services utilizing the debit card or other payment means provided by the financial institution. Preferably, the financial institution will then immediately transfer the payment to the medical provider, thereby reducing the amount of time the medical provider must wait to be paid and eliminating any uncertainty with regard to whether the payment will be received. A relatively small transaction fee, typically three to five percent of the fees for the medical services, is paid to the managing organization from the consumer's pre-approved funds for its services. In the preferred embodiment, the managing organization is also paid a merchant acquisition fee by the medical providers who desire to participate in the funding and payment program of the present invention.

Accordingly, the primary objective of the present invention is to provide an improved program for funding and paying for medical services that has the advantages described above and that overcomes the disadvantages and limitations of presently available methods of funding and paying for the expenses associated with medical services, particularly elective medical procedures.

It is an important objective of the present invention to provide an improved program for funding and paying for medical expenses that allows a consumer of medical services, particularly elective procedures, to obtain funds which are utilized to obtain the desired services when conventional funding sources are not available and which directs full payment for the services to the medical provider.

It is also an important objective of the present invention to provide an improved program for funding and paying for medical expenses that allows the consumer to have control over the medical procedure he or she wants to have performed, the timing for having the medical procedure performed, the location for the medical procedure and the selection of the medical provider.

It is also an important objective of the present invention to provide an improved program for funding and paying for medical expenses that engages lending institutions to pre-qualify a consumer for funds which are utilized for the medical services of the consumer's choice, arranges for funding for the consumer at a payment rate he or she can afford and forwards payment for the medical services directly to the medical provider.

Another important objective of the present invention is to provide a program of funding and paying for medical expenses, particularly with regard to elective medical procedures, that helps employers and the employee/consumer with regard to a variety of medically-related issues, including oversight of the medical providers, selection of medical providers with the desired credentials and experience, the understanding of the anticipated outcomes for a particular medical procedure, the costs of selected procedures and other medical-related performance measures.

Yet another objective of the present invention is to provide a funding and payment program for medical expenses that has an easier and more direct method of obtaining funding for medical expenses, specially elective procedures and the like, and which has a payment process that results in a more direct and faster payment to the provider.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a diagram showing the relationships between the various participants of a preferred configuration of the medical expenses funding and payment program of the present invention;

FIG. 2 is a flow diagram summarizing the method of the medical expenses payment program of the present invention; and

FIG. 3 is a diagram showing the transfer of funds between the various participants in a preferred configuration of the medical expenses funding and payment program of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of a preferred embodiment and represent one of several different ways of configuring the present invention. Although specific exemplary configurations and/or uses of the present invention are set forth in the drawings and specification, those skilled in the art will readily understand that these examples are only provided to explain the principles of the present invention and are not intended to unduly restrict the scope thereof. In fact, those of ordinary skill in the art will readily appreciate that the invention teaches many variations and modifications such that a number of variations or modifications can be employed without changing the scope and spirit of the invention set forth herein.

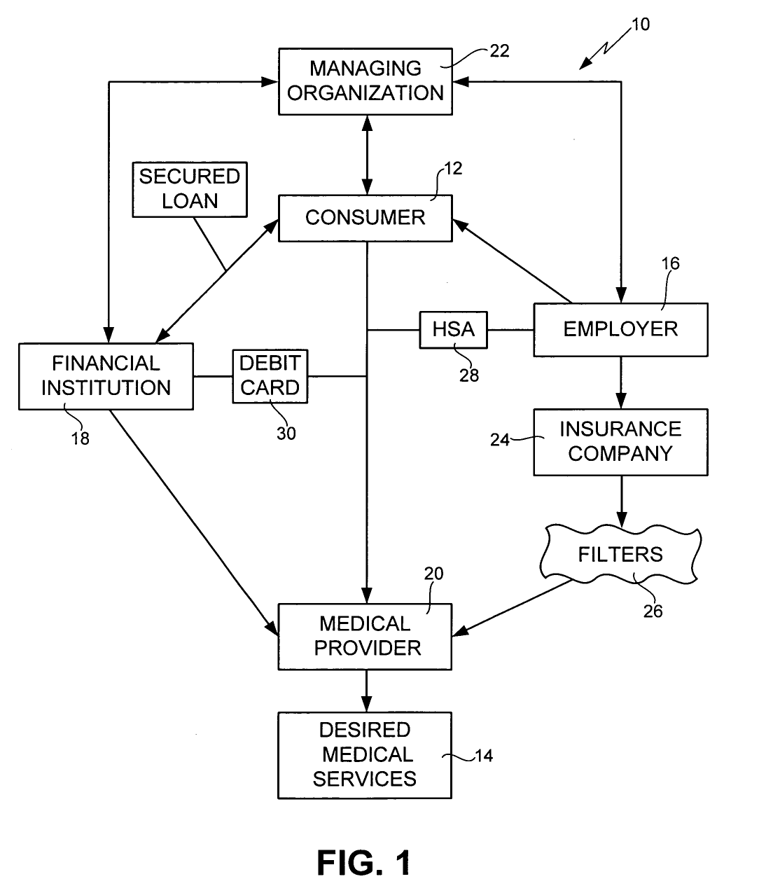

In reference to FIGS. 1 through 3, one of the preferred embodiments of the medical expenses funding and payment program of the present invention, identified in the figures generally as 10, is configured to facilitate a consumer 12 obtaining the desired medical services 14 when funding or reimbursement for such services are not available through traditional sources, including medical insurance, employer-based insurance programs and the like. As best shown in FIG. 1, the primary other participants in the funding and payment program 10 of the present invention are the consumer's employer 16, a participating financial institution 18, the medical providers 20 and the managing organization 22. The respective roles of and benefits of the funding and payment program 10 for the various participants are described below. For purposes of the present disclosure, the term financial institution 18 refers to traditional lending institutions such as banks, credit unions or the like, or any separately formed private or publically traded entity that lends money or a governmental agency. The term medical providers 20 refers to any person or organization that provides medical services 14 to consumers 12, including but not limited to general practice doctors, hospitals, surgery centers, urgent care centers, dentists, cosmetic surgeons, chiropractors, physical therapists, individual practice associations or the like.

Presently, when the consumer 12 requires medical services 14 he or she will typically seek approval for those services 14 from the employer's insurance company 24 prior to having any medical procedures performed to ensure that the medical services 14 are within the terms of the insurance policy. The insurance company 24 will apply certain filters 26, such as HMO and other insurance restrictions based on the medical insurance policy selected by the employer 16, to the consumer's request for medical services 14. Typically, a portion of the insurance premiums for the medical insurance policy is paid for by the employer 16 and the remainder is paid by the consumer 12, often through payroll deductions. Many consumers 12 will have a HSA 28 associated with their place of employment, with the employer 16 directing a portion of the consumer's payroll to the HSA 28. The amount of money placed into the HSA is selected by the consumer 12, within the limits of the law authorizing the HSA. Based on the filters 26 which are associated with an employer's insurance policy or government policy, the insurance company 24 will either approve or deny the request by the consumer 12 for the desired medical services 14. Any approved medical services 14 are still subject to deductibles or other charges that must be paid by the consumer 12, either through funds available in the HSA 28 or from the consumer's own resources (e.g., bank checking or savings accounts). If the desired medical services 14 are deemed to be elective or otherwise not included in the insurance plan, then the request for coverage will be denied by the insurance company 24. If the consumer 12 nevertheless desires to have such medical services 14 performed, then he or she will have to completely pay for such medical services from the HSA 28 or his or her own resources.

The requirement for the consumer 12 to pay for elective medical services, which typically includes many types of plastic surgery, weight loss, in vitro or other types of artificial fertilization and dental procedures (among others), creates a number of problems. One such problem is that the consumer 12 must utilize his or her financial resources, which may not be available or be somewhat limited. If the funds for the medical services 14 are not available to the consumer 12, then he or she must borrow the money. Although the consumer 12 can go directly to the financial institution 18 and obtain a loan, most financial institutions 18 are not amenable to making such loans or, if they approve such a loan, the loan is made at a somewhat high interest rate, particularly in light of the fact that such loans are typically unsecured. Alternatively, the consumer 12 can utilize a credit card, also typically at relatively high interest rates, to pay for the elective medical services 14. A common result of this problem is that the consumer 12 makes the decision to forego the elective, but desired, medical services 14. In addition to affecting the consumer 12, such decisions also impact the use and, therefore, the profitability of medical providers 20. Another problem with the present system of funding, or lack thereof, for elective medical services 14 is that the medical provider 20 must deal with receiving payments from the insurance company 24 and/or the consumer 12, either of which often results in the medical provider 20 receiving less than was originally charged and/or having a somewhat large amount of accounts receivable on their books. In addition, the medical provider 20 must have sufficient staff available to handle the receipt of payments, accounts receivable tracking and any necessary collection activities.

The medical expenses funding and payment program 10 of the present invention solves the problems associated with a consumer 12 obtaining funding for medical services 14 directed to elective or otherwise non-insured medical procedures. Initially, the managing organization 22 will make various arrangements with employers 16, financial institutions 18 and medical providers 20 to put into place the program 10 of the present invention. As set forth in more detail below, the managing organization 22 will set-up beneficial funding sources for the consumer, identify medical providers 20 who provide the various medical services 14 to be sought by the consumer 12 and facilitate payment to the medical providers 20 for those services 14. Once the program 10 is in place, the consumer 12 will decide that he or she wants certain medical services 14 to be performed. As is presently done, the consumer 12 will contact the insurance company 24 to verify coverage for the desired medical services 14. If the desired medical procedure is deemed elective, as are most “vanity” type of procedures, then the insurance company 24 will deny coverage for the medical services 14. If the consumer 12 is unable or unwilling to utilize his or her own funds or sufficient funds are not available, whether through the consumer's own accounts or their HSA, then he or she can be directed, typically by his or her employer 16, to the funding and payment program 10 of the present invention.

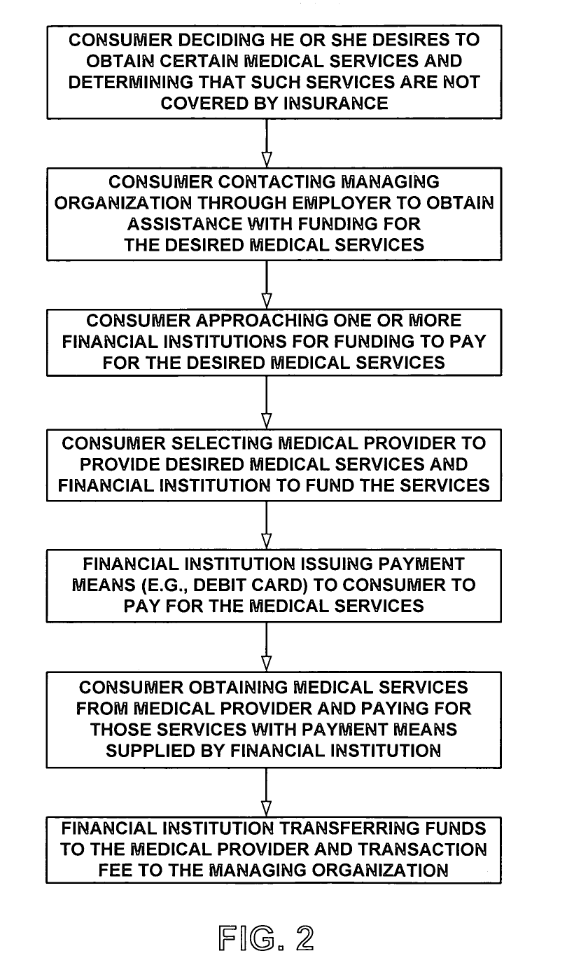

As summarized in FIG. 2, the consumer 12 will contact the managing organization 22 for assistance with funding for the desired medical services 14 and with identifying medical providers 20 who work with the program 10 to provide such services 14. As shown in FIG. 1 and set forth below, the managing organization 22 will have a relationship with the employer 16 and a variety of financial institutions 18. The managing organization 22 will provide the consumer 12 with information about the medical services 14 he or she seeks, including the cost of the procedure, the type of medical providers 20 that provide those procedures, the qualifications and experience of medical providers 20 with whom the managing organization 22 has a relationship and the risks and anticipated outcomes of the desired procedure. The managing organization 22 will also assist the consumer 12 with the financial arrangements for paying for the medical services 14 being sought. The managing organization 22 will assist in identifying the additional funds that the consumer 12 requires, which are in addition to funds the consumer 12 has or has access to (e.g., through a HSA) and then help him or her with obtaining funding to cover the remaining anticipated costs. Through arrangements with a variety of financial institutions 18 and the consumer's employer 16, the managing organization 22 can assist the consumer 12 with obtaining a loan to cover the additional costs for the medical services 14 at terms, including interest rates and payments, that are more favorable to the consumer 12 than he or she could obtain on their own. In addition, through its relationship with medical providers 20, the managing organization 22 will be able to direct the consumer to medical providers 20 that participate in the funding and payment program 10 of the present invention, thereby ensuring that the consumer 12 is obtaining the medical services 14 from a pre-screened medical provider 20 who is familiar with the program 10. Preferably, the managing organization 22 will also be able to obtain discounted costs for the selected medical procedures 14 from medical providers 20 who are part of the program 10. Although the managing organization 22 will assist the consumer 12 with type of medical services 14 he or she desires, the selection of medical providers 20 who provide those services 14 and the funding, the consumer 12 will have the final decision with regard to the medical services 14 and which medical providers 20 and financial institutions 18 he or she desires to work with to obtain those services 14.

With direction from the managing organization 22, the consumer 12 will approach the financial institution 18 to assist him or her with funding the desired medical services 14. Preferably, the financial institution 18 will have a relationship with the consumer's employer 16, such as handling the employer's debt management, bank accounts and HSA, to provide incentive for the financial institution 18 to offer a more favorable rate to the employee/consumer 12 than it would otherwise normally provide a person seeking such a loan. In addition, preferably the financial institution 18 will look at packaging the consumer's entire debt issues, including mortgage, auto loan, investments, IRAs, pensions and credit cards, to provide further incentive to the financial institution 18 to provide more favorable terms to the consumer 12. One effect of the program 10 of the present invention is to convert the funding for the desired medical services 14 from unsecured debt to secured debt, which generally results in much better loan terms for the consumer 12. In addition, one feature of the program 10 of the present invention is that the consumer 12, with assistance from the managing organization 22 and/or the financial institution 18, may be able to obtain a tax free loan or at least a tax advantaged loan through use of IRA and/or 401K funds for use to pay for the desired medical services 14. Another unique feature of program 10 is that it facilitates bundling of debt and assets to achieve a lower and more affordable interest rate for the consumer 12. This bundling of asset-based financial products for medical services 14 provides pre-paid health care that is controlled by the consumer 12.

With information from the managing organization 22, the financial institution 18 will be able to determine the cost of the sought after medical services 14 and the amount of funding the consumer 12 requires to obtain those medical services 14. The financial institution 18 will provide the consumer 18 with a pre-approved payment means for paying for the medical services 14. In a preferred embodiment, shown in FIGS. 1 and 2, the payment means is a debit card 30 or like card which can be presented to the medical provider 20 to pay for the medical services 14. In this embodiment, the consumer 12 would “swipe” the card 30 at the medical provider's office and the funds would be transferred to the medical provider 20 by the financial institution 18, thereby eliminating issues of whether the medical provider 20 will be paid and when, which is a major benefit of the present program 10 for medical provider 20. In an alternative embodiment, the financial institution 18 can provide a call-in number, such as an “800” number for the medical provider 20 to use to verify the funds are available and to transfer funds to the medical provider 20 for the medical services 14.

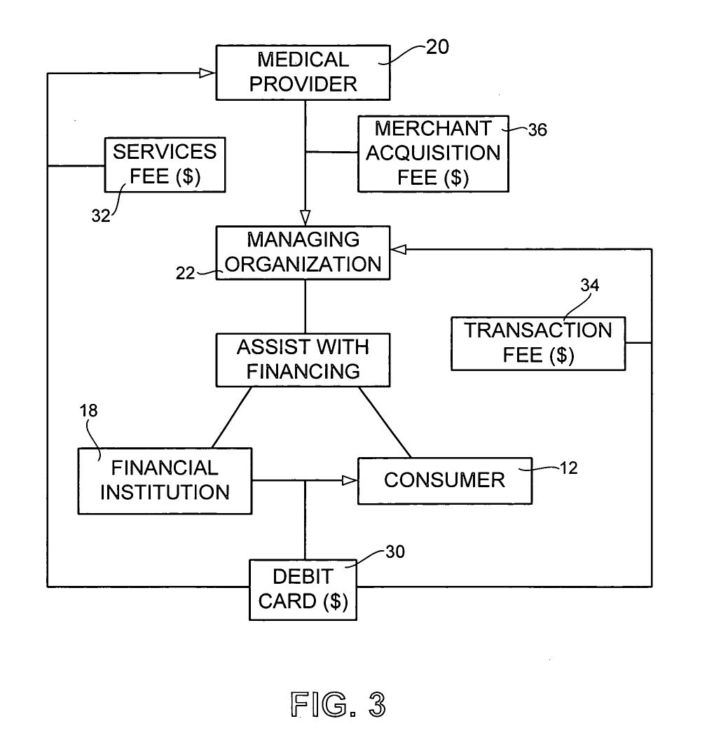

After receiving the pre-approval from the financial institution 18 and the payment means, such as debit card 30, to pay for the desired medical services 14, the consumer then selects a medical provider 20 to provide those services 14. The consumer 12 could select the medical provider 20 based on availability, credentials, experience and/or costs, information which can be provided to the consumer 12 by the managing company 22 so as to assist him or her with the selection of medical provider 20 (i.e., independent of the managing company 22). As the final decision is the consumer's to make with regard to the selection of medical services 14 and medical provider 20, the consumer 12 may base his or her decision on the above or any other factors as he or she may desire. The consumer 12 then obtains the desired medical services 14 from the medical provider 20 and pays for those services 14 utilizing the payment means, such as the debit card 30, provided by the financial institution 18, as shown in FIG. 3. Preferably, the financial institution 18 electronically transfers the approved funds, shown as the “services fee” 32 in FIG. 3, to the medical provider 20 to speed the payment to the medical provider 20. If desired, other payment methods can be utilized, such as a payment by check or other device. In addition, as set forth below and shown in FIG. 3, a pre-set percentage of the cost of the medical services 14 (i.e., typically less than five percent) is forwarded to the managing organization 22 as a transaction fee for providing the assistance to the consumer 12 and facilitating the arrangement between the financial institution 18 and medical provider 20. One advantage of the program 10 is that the financial institution 18 is better equipped to deal with the consumer with regard to financial arrangements than are medical providers 20, particularly in the usual scenario where there are multiple medical providers 20 providing the medical services 14 to the consumer 12.

The consumer 12 receives the primary benefits of the funding and payment program 10 of the present invention and, as such, has an important role in the operation of the program 10. As a result of the present invention, the consumer 12 is able to obtain and pay for medical services 14 of his or her choice when the services 15 are not covered by existing health insurance, including their employer-provided insurance plan, and without having the funds previously available to him or her in their own savings or in their HSA. Typically, program 10 will be most beneficial for elective, non-critical procedures, including in vitro fertilization, orthodontics, dentistry, bariatric surgery, cosmetic surgery, PT/OT therapies, psychiatry and the like. In addition, the consumer 12 may be able to obtain therapies, such as stem cell therapy, that are not available in the United States (in addition to not being covered by insurance). Through the managing organization 22, the consumer 12 can obtain information about the medical services 14 they seek, medical providers 20 who provide those services 14 and assistance with funding the desired services 14. In the program 10 of the present invention, the consumer 12 has the ultimate control over the use of the program 10, including timing and selection of the medical provider 20, to obtain medical services 14. In addition, the consumer 12 receives the benefit of the quality control assurance procedures of the managing organization 22 and information about medical services 14 and medical providers 20 that would be otherwise very difficult to obtain. By working with the financial institution 18 that is associated with the managing organization 22 and/or the consumer's employer 16, the consumer 12 can obtain more favorable loan terms, including a lower interest rate, than he or she could obtain on their own. Because the consumer 12 in effect becomes a “cash patient” as a result of his or her participation in the program 10, he or she will be more favorably viewed by potential medical providers 20, perhaps even sought after, than consumers 12 who come to the medical provider 20 “burdened” by health insurance limitations that require the medical provider 20 to deal with the insurance company 24 and its filters 26.

The benefit of the funding and payment program 10 to the employer 16 includes lower cost insurance programs and more favorable relationships with their employees, the consumer 12. The employer 16 can purchase health insurance policies for their employees that are primarily limited to major medical or catastrophic coverage and provide a HSA to allow the employee/consumer 12 to set aside funds for routine medical expenses. Such a change could result in a significant decrease in insurance premiums for the employer 16. Although this may result in a larger deductible or higher co-pays to the consumer 12, it can be offset with the ability of the consumer 12 to be able to obtain funding for medical services 14 not covered by the insurance policy. This will also have the effect of generally removing the insurance company 24 from the equation except for those medical procedures and services which fall within the scope of the major medical coverage, which should lessen the insurance issues for the employer 16. The employer 16 also has the benefit of having the managing organization 22 to direct the consumer 12 to so he or she may obtain information and funding assistance regarding the medical services 14 outside of the employer's standard health insurance plan.

The financial institution 18 benefits by having a new source of loan applicant's that, preferably, are employees of an employer 16 with whom the financial institution 18 already as a relationship. This allows the financial institution 18 to cross-market its various financial products to the consumer 12 and to medical providers 20. Through the funding and payment program 10, the financial institution 18 can bundle many of its financial products together in a manner that benefits both the consumer 12 and the financial institution. The financial institution 18 also benefits through its association with the managing organization 22, which provides qualified risk management, typically by the disease, procedure, acuity and ICD codes. The program 10 allows the financial institution 18 relatively easy entry into the health care management field, which can be a lucrative source of customers for the financial institution 18.

The medical providers 20 benefit from their participation in the program 10 by having more consumers 12 being able to afford and benefit from the medical services 14 they provide, particularly those that are not normally covered by employer or other health insurance plans. Additionally, the medical providers 20 receive an improvement in the payor mix of their patients, namely an increase in “cash patients” that can off-set the limitations of the typical insurance patients. The medical providers 20, particularly the larger providers such as hospitals and large private surgery centers and clinics, will see a reduction in their overhead due to the need to have less employees involved in accounts receivable activity. Medical providers 20 of all sizes will benefit by having less collection issues, a reduction in outstanding accounts and faster payments for the medical services 14. Smaller medical providers 20, such as doctors and smaller clinics, will benefit by being able to focus on particular practice areas independent of whether the medical services 14 are covered by medical insurance. In addition, medical providers 20 will be able to shift a large portion of the financial issues pertaining to their elective procedure practice to the financial institutions 18, which are generally better at preforming such tasks. Using the debit card 30 or like feature as the payment means, medical providers 20 will be able, if desired, to offer short term discounts or promotions to customers 12 who obtain a particular medical service 14 by a particular date. Although some medical providers 20 may have issues with regard to loss of the better “cash patients” to other institutions and with the third party benchmarking and profiling that will be provided by managing organization 22, most medical providers 20 will understand the benefits of having program 10 available.

The managing organization 22 will have an important role in the funding and payment program 10 of the present invention. In addition to setting up the program 10, the managing organization 22 will coordinate interaction between the consumer 12, his or her employer 16, the financial institution 18 and the medical providers 20, as shown in FIG. 1, to assist the consumer 12 with obtaining the medical services 14 that are normally not covered by health insurance plans. To contact consumers 12, the managing organization 22 will develop relationships with a variety of employers 16 and demonstrate to those employers 16 how the program 10 can reduce costs to the employer 16 while providing their employees (potential consumers 12) with increased flexibility with regard to their health care and obtaining discretionary or elective medical services 14. The employers 16 will inform their employees about the benefits provided by the program 10 and contact information for managing organization 22. The managing organization 22 will also develop relationships with a variety of financial institutions 18 who may be able to provide the consumer 12 with the funding necessary to obtain the medical services 14 that are not covered under existing health insurance plans. The managing organization 22 will contact medical providers 20 for interest in participating in the program 10. The subject medical providers 20 will be selected for such participation based on credentials, including their particular expertise and experience. Often the medical providers 20 will be regionally identified so consumers 12 in a particular geographical area can have medical providers 20 whom they can contact for the desired medical services 14. The managing organization 22 will develop lists of medical providers 20 who are qualified to provide particular medical services 14 and information regarding the various types of medical services 14 that they provide, including risks, potential complications, recovery periods and alternatives for such services 14. Over time, the managing organization 22 will compile a variety of customer satisfaction and related information that will be at least generally useful to the consumer 12 as he or she selects the medical provider 20 to provide the desired medical services 14.

For the various services and assistance it provides, the managing organization 22 can benefit financially from the use of the program 10 by the consumer 12. Preferably, the financial stream to the managing organization 22 should be automatic, requiring no billing or collection activities by the managing organization 22. In a preferred embodiment, which is summarized in FIG. 3, the managing organization 22 will receive a transaction fee 34 as a percentage of the services fee 32 each time the payment means, such as debit card 30, is used to pay for medical services 14 at any of the pre-approved medical providers 20. In the preferred embodiment, the transaction fee 34 will be included in the pre-approved funds provided to the consumer 12 by the financial institution 18 and, therefore, will be paid by the consumer 12 at the time he or she pays for the medical services 14. As an example, each time the debit card 30 is “swiped,” the managing organization 22 can receive three to five percent of the total amount of the fee. If desired, the transaction fee 34 can be capped at a certain amount, such as $10,000.00, for each case. In addition to the transaction fee 34, the managing organization 22 can collect a merchant acquisition fee 36 from each medical provider 20 who desires to participate in the funding and payment program 10 of the present invention. The merchant acquisition fee 36 can be utilized to offset the costs to the managing organization 22 of compiling the information about the medical provider 20 that is necessary to have available to the consumer 12 so that he or she may make an intelligent decision regarding the choice of medical provider 20 to provide the desired medical services 14.

The program 10 of the present invention is also useful for obtaining medical services 14 outside of the United States or outside the country where the customer 12 is employed. A relatively recent phenomena is for residents of the United States to obtain medical services 14 from medical providers 20 located outside the United States. The reasons for this phenomena, commonly referred to as “medical tourism,” is to take advantage of lower medical costs in developing countries and/or to utilize cutting edge medical technology that is either not legal or not available in the United States, such as certain transplant or stem cell surgeries (among others). Customers 12 interested in obtaining medical services 14 outside the United States could utilize the debit card 30, or other payment means, to fund and pay for the medical services 14 from select foreign medical providers 20. The managing organization 22 could assist in financing and arranging for such medical services 14. The managing organization 22 could increase their income by collecting funds in U.S. Dollars or Euros and purchasing medical services 14 in the currency of the developing country.

The program 10 could also be utilized by state or federal government agencies to allow non-resident persons, referred to herein as expatriates, in the United States or other countries to travel back to their home country and receive medical services 14 from a “hometown” medical provider 20. This is likely to be appealing to many expatriate customers 12 because it allows them to obtain medical services 14 from a medical provider 20 in their own country, where they are likely to have family members available to assist them in their recovery, as opposed to local “foreign” emergency rooms. In addition, such a use of program 10 would also be beneficial to various local public and private entities, such as government agencies, hospitals, doctors and the like, by reducing the reliance on and use of emergency rooms by non-resident expatriate persons. Similarly, foreign governments and/or business employers in foreign countries who employ non-resident persons for many different types of occupations, which is common in certain Middle Eastern and other countries, can utilize program 10 to allow such expatriate persons to go back to their home country to receive medical services 14 from medical providers 20 located in that country. Use of the program 10 in such circumstances could substantially reduce use of local medical providers 20 by non-resident persons for most non-emergency types of medical services 14, therefore reserving the local medical facilities and personnel for residents and for emergency care.

In use, the managing organization 22 sets up the framework of the program 10, contacts a number of employers 16, financial institutions 18 and medical providers 20 who may be interested in participating in the program 10 and compiles information regarding the medical providers 20 and the medical services 14 they provide. The managing organization works with the employers 16 to assist in notifying the employees/customers 12 about the program, works with the financial institutions to set-up the payment means, such as the debit card 30, and works with medical providers 20 to identify medical specialties in a variety of different geographical areas. Typically, each of medical provider 20 will pay an merchant acquisition fee 36 to the managing organization in order to participate in the program 10. When a consumer 12 decides he or she wants to have a medical service 14 that is not covered by his or her insurance plan, they will contact the managing organization 22 with help in obtaining funding for the desired medical service 14 and information regarding the types of procedures, the risks associated with those procedures and identification of medical providers 20 who specialize in that type of procedure. The managing organization 22 will assist the consumer 12 with determining the likely costs of the desired medical services 14 by utilizing information compiled by the managing organization 22 and with obtaining funding to cover those costs by placing the consumer 12 in contact with one or more financial organizations 18 that are participating in the program 10. The consumer 12 will choose a participating medical provider 20 and then have the selected medical procedure performed. The payment of the services fee 32 to the medical provider 20 will be by the payment means, such as debit card 30, provided by the financial institution 18 and, as such, will be assured and immediate. A small percentage of the fee will be directed to the managing organization 22 as a transaction fee 34. If desired, the managing organization 22 can also act as the financial institution 18 and issue the debit card 30 or other payment means itself.

Various variations of the program 10 of the present invention are available. For instance, the payment means can be virtually any type of present or future method that is suitable for paying the medical provider 20 with the payment for its services. This includes debit card 30, other types of payment cards or devices, including checks and the like, any type of electronic transfer between the financial institution 18 and medical provider 20, telephone transfers, bank or wire transfers, and the like. If desired, the payment means, such as debit card 30, can include a near field communication (“NFC”) chip or device that would allow information to be wirelessly transmitted directly to the payment means so the consumer 12 could review the information. For instance, information related to a medical provider 20 and/or the costs of certain medical services 14 could be provided directly to the consumer 12 via the payment means (i.e., debit card 30) so he or she may make a better and faster informed decision regarding a desired course of action.

While the figures and description herein has set forth one or more preferred embodiments of the present invention, it will be readily apparent to those skilled in the art that the invention is not so limited, but is susceptible to various modifications and rearrangements without departing from the spirit and scope of the invention. For instance, many of the fundamental components used with the invention and described herein have equivalent functioning components that are well known with the art that can be used with the present invention. It is to be understood, therefore, that various modifications and rearrangements to the invention are contemplated herein. As such, the foregoing description is intended to be illustrative rather than limiting. The following claims, including all legal equivalents thereto, are intended to define the spirit and scope of the present invention.

What is claimed is:

1. A method of funding and paying for medical expenses, said method comprising the steps of:
a) a consumer deciding to obtain a medical service;
b) said consumer contacting a managing organization to obtain assistance with obtaining funds to pay for said medical service;
c) said consumer approaching one or more financial institutions to obtain funds for said medical service;
d) said consumer selecting a medical provider to provide said medical service and selecting one of said one or more financial institutions to provide funding;
e) said selected financial institution issuing a payment means to said consumer for paying said medical provider for said medical service;
f) said consumer obtaining said medical service from said medical provider and paying for said medical service with said payment means issued by said financial institution; and
g) said financial institution transferring a services fee to said medical provider for said medical service and a transaction fee to said managing organization.

2. The method according to claim 1, wherein said contacting step is achieved through an employer associated with said consumer.

3. The method according to claim 1, wherein said financial institution is identified by said managing organization prior to said consumer approaching step.

4. The method according to claim 1, wherein said payment means is a debit card.

5. The method according to claim 1, wherein said payment means is associated with said selected medical provider.

6. The method according to claim 1 further comprising the step of compiling information by said managing organization regarding said medical provider, said medical service and said financial institution prior to said consumer deciding step.

7. The method according to claim 6, wherein said medical provider pays a merchant acquisition fee to said managing organization prior to said information compiling step.

8. The method according to claim 1, wherein said managing organization assists said consumer by identifying the cost of said medical service.

9. The method according to claim 8, wherein said managing organization assists said consumer by identifying said medical provider who provides said medical service.

10. The method according to claim 1, wherein said consumer is an expatriate and said program is utilized by said expatriate to receive said medical service in their home country.

11. The method according to claim 1, wherein said program is utilized to subsidize or enhance government programs in alliance with said medical provider.

12. The method according to claim 1, wherein said program benefits an employer by allowing said employer to lower the cost of medical benefits provided to said consumer.

13. A method of funding and paying for medical expenses, said method comprising the steps of:
a) a consumer deciding to obtain a medical service that is not covered by insurance;
b) said consumer contacting a managing organization to obtain assistance with identifying the costs of said medical service, identifying one or more medical providers who provide said medical service and identifying one or more financial institutions to obtain funds to pay for said medical service;
c) said consumer approaching at least one of said one or more financial institutions to obtain funds for said medical service;
d) said consumer selecting at least one of said one or more medical providers to provide said medical service and one of said one or more financial institutions to provide funding;
e) said selected financial institution issuing a payment means to said consumer for paying said medical provider for said medical service;
f) said consumer obtaining said medical service from said medical provider and paying for said medical service with said payment means issued by said financial institution; and
g) said financial institution transferring funds to said medical provider for said medical service and a transaction fee to said managing organization.

14. The method according to claim 13, wherein said payment means is a debit card.

15. The method according to claim 13, wherein said payment means is associated with said selected medical provider.

16. The method according to claim 13 further comprising the step of compiling information by said managing organization regarding said medical provider, said medical service and said financial institution prior to said consumer deciding step.

17. The method according to claim 16, wherein said medical provider pays a merchant acquisition fee to said managing organization prior to said information compiling step.

18. A system of funding and paying for medical expenses, said system comprising:
a consumer desiring to obtain a medical service;
a medical provider to provide said medical service;
a financial institution to provide funding for said medical service;
payment means issued by said financial institution to said consumer for paying said medical provider for said medical service; and
a managing organization to assist said consumer by identifying the cost of said medical service, identifying said medical provider and identifying said financial institution,
wherein said consumer obtains said medical service from said medical provider and pays for said medical service with said payment means and said financial institution transfers a services fee to said medical provider for said medical service and a transaction fee to said managing organization.

19. The system according to claim 18, wherein said consumer is an expatriate and said program is utilized by said expatriate to receive said medical service in their home country.

20. The system according to claim 18, wherein said payment means is a debit card.
